(19) United States
(12) Patent Application Publication
(10) Pub. No.: US 2014/0380061 A1
(43) Pub. Date: Dec. 25, 2014

(54) Implementation Method of a Multifunctional MCU and such Multifunctional MCU

(71) Applicant: GOLDEN VAST MACAO COMMERCIAL OFFSHORE LIMITED, Macao (CN)

(72) Inventor: Kwok fong Wong, MACAO (CN)

(73) Assignee: GOLDEN VAST MACAO COMMERCIAL OFFSHORE LIMITED, Macao (CN)

(21) Appl. No.: 14/306,257

(22) Filed: Jun. 17, 2014

(30) Foreign Application Priority Data
Jun. 20, 2013 (CN) 201310248294.5

(51) Int. Cl. G06F 21/32; H04L 9/08

(52) U.S. Cl. CPC G06F 21/32; H04L 9/0866
USPC 713/189; 726/19

(57) ABSTRACT

A method comprises steps of: acquiring a function operation instruction input by a user; and scanning a fingerprint of the user and performing identity authentication on the user according to the fingerprint, if an operation corresponding to the function operation instruction is authentication; storing data information into a preset storage space, if an operation corresponding to the function operation instruction is data information storage; charging a preset device, if an operation corresponding to the function operation instruction is charging. The multifunctional MCU comprises an acquisition module, an authentication module, a storing module and a charging module.

The application is related to Chinese application Ser. No. CN201310248294.5, filed on Jun. 20, 2013 and entitled “An Implementation Method of a Multifunctional MCU and such Multifunctional MCU”, which is hereby incorporated herein by reference.

### FIELD OF THE INVENTION

The invention relates to the field of electronic technology, more particularly to an implementation method of a multifunctional MCU as well as such multifunctional MCU.

### DESCRIPTION OF THE RELATED ART

With the extensive application of mobile terminals such as a mobile phone, in order to improve the functions of mobile terminals without structure variation, various auxiliary electronic devices has been developed for mobile terminals, such as fingerprint storage devices combined by fingerprint authentication devices with storages, fingerprint chargers combined by fingerprint authentication devices with chargers.

However, the existing fingerprint storage devices and fingerprint chargers only are combined simply by modules, such type of devices will not have sufficient functions due to the limitations of size of modules, and generally some particular functions are defined in these devices, thus a user only can use such limited functions in these devices.

### SUMMARY OF THE INVENTION

In order to solve the problems of the prior art, a multifunctional MCU is provided in the invention.

The technical solutions of the invention are disclosed as follows:

In one aspect, the invention provides an implementation method of a multifunctional MCU, comprising steps of:
acquiring a function operation instruction input by a user; and
scanning a fingerprint of the user and performing identity authentication on the user according to the fingerprint, if an operation corresponding to the function operation instruction is authentication;
storing data information into a preset storage space, if an operation corresponding to the function operation instruction is data information storage;
charging a preset device, if an operation corresponding to the function operation instruction is charging.

In another aspect, the invention provides a multifunctional MCU, comprising:
an acquisition module, for acquiring a function operation instruction input by a user;
an authentication module, which is used for scanning a fingerprint of the user and performing identity authentication on the user according to the fingerprint, when an operation corresponding to the function operation instruction acquired by the acquisition module is authentication;
a storing module, which is used for storing data information into a preset storage space, when an operation corresponding to the function operation instruction acquired by the acquisition module is data information storage; and
a charging module, which is used for charging a preset device, when an operation corresponding to the function operation instruction acquired by the acquisition module is charging.

As compared with the prior art, the technical solutions of the invention have the following advantages:

By means of acquiring a function operation instruction, a user can conveniently utilize a plurality of functionalities, such as authentication, data information storage and charging, according to an operation corresponding to the function operation instruction.

### BRIEF DESCRIPTION OF THE DRAWINGS

The accompanying drawings of the embodiments will now be described simply, so that the technical solutions in embodiments of the invention can be illustrated more clearly. Obviously, the drawings described hereinafter only refers to some preferred embodiments of the present invention, other equivalent drawings can be obtained by a person skilled in the art without any creative works.

FIG. 1 is a flow chart of the implementation method of a multifunctional MCU according to embodiment 1 of the invention;

FIG. 2 is a schematic diagram of a first multifunctional MCU according to embodiment 2 of the invention;

FIG. 3 is a schematic diagram of a second multifunctional MCU according to embodiment 2 of the invention;

FIG. 4 is a schematic diagram of a third multifunctional MCU according to embodiment 2 of the invention;

FIG. 5 is a schematic diagram of a fourth multifunctional MCU according to embodiment 2 of the invention;

FIG. 6 is a schematic diagram of a fifth multifunctional MCU according to embodiment 2 of the invention;

FIG. 7 is a schematic diagram of a sixth multifunctional MCU according to embodiment 2 of the invention;

FIG. 8 is a schematic diagram of a seventh multifunctional MCU according to embodiment 2 of the invention;

FIG. 9 is a schematic diagram of an eighth multifunctional MCU according to embodiment 2 of the invention;

FIG. 10 is a schematic diagram of a ninth multifunctional MCU according to embodiment 2 of the invention;

FIG. 11 is a schematic diagram of a tenth multifunctional MCU according to embodiment 2 of the invention;

FIG. 12 is a schematic diagram of an eleventh multifunctional MCU according to embodiment 2 of the invention;

FIG. 13 is a schematic diagram of a twelfth multifunctional MCU according to embodiment 2 of the invention;

FIG. 14 is a schematic diagram of a thirteenth multifunctional MCU according to embodiment 2 of the invention.

### DETAILED DESCRIPTION OF THE INVENTION

Preferred embodiments of the present invention will now be described in more detail hereinafter with reference to the drawings, so that the advantages and features of the invention can be easily understood by a person skilled in the art, thereby the protection scope of the invention can be defined more clearly.

### Embodiment 1

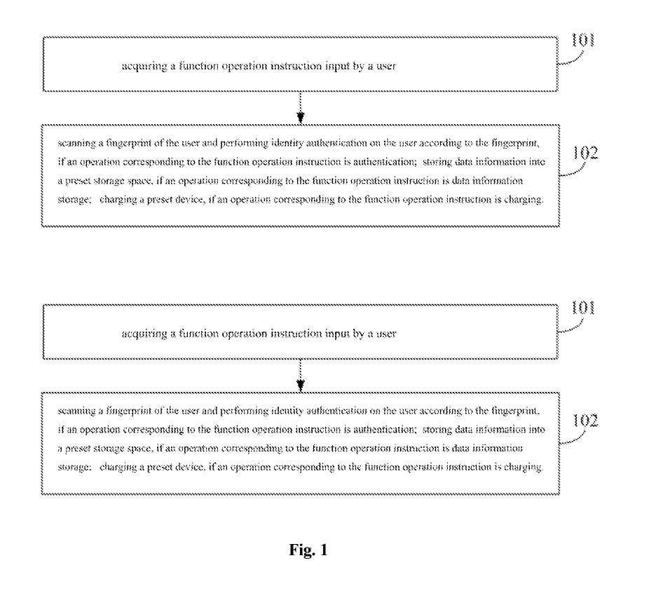

The embodiment 1 of the invention provides an implementation method of a multifunctional MCU (Micro Control Unit), as shown FIG. 1, the method comprises steps of:
101: acquiring a function operation instruction input by a user; and
102: scanning a fingerprint of the user and performing identity authentication on the user according to the fingerprint, if an operation corresponding to the function operation instruction is authentication; storing data information into a preset storage space, if an operation corresponding to the function operation instruction is data information storage; charging a preset device, if an operation corresponding to the function operation instruction is charging.

Specifically, the data information may be fingerprint information of a user, or application information which is generated when a user utilizes various applications in mobile terminals, or alternatively various dada information desired to be stored by a user and the like.

Specifically, charging a preset device may be carried out by means of a preset cell or a preset wireless charging.

Preferably, the method also comprises the step of:
transmitting data during preset devices, if an operation corresponding to the function operation instruction is data transmission.

Specifically, data transmission can be performed in many ways according to the different user's gestures which can be obtained by means of touching, for example, the data transmission may be one-to-one or one-to-many, and also the data may be encrypted during transmission.

More specifically, data transmission can be achieved by a preset data transmission module, such as, Infrared, Bluetooth, Wired Communication Interface, NFC, Wifi, and Waveconex.

More preferably, the method also comprises the step of:
generating a public key and a private key according to the fingerprint of the user, and transmitting the public key to a preset storage space and storing the private key to a preset storage space, if an operation corresponding to the function operation instruction is key generation.

Wherein the preset device may be for example a server and the preset storage space may be provided locally or in the preset device.

More preferably, the method also comprises the step of:
encrypting preset communication information or a preset communication file by means of the public key, and transmitting the encrypted communication information or communication file to a receiving terminal, if an operation corresponding to the function operation instruction is encryption.

Wherein the preset communication information may be E-mail, instant conversation, voice, short message or the like input by a user, and the preset communication file may be a text file or an audio-video file or the like.

More preferably, the method also comprises the step of:
decrypting encrypted communication information or an encrypted communication file by means of the private key to obtain decrypted communication information or a decrypted communication file, if an operation corresponding to the function operation instruction is decryption.

More preferably, the method also comprises the step:
locking a preset screen if an operation corresponding to the function operation instruction is screen locking.

More preferably, the method also comprises the step:
locking a preset application program if an operation corresponding to the function operation instruction is application program locking.

Specifically, an unauthorized user can not use this application program after the preset application program is locked.

More preferably, the method also comprises the step of:
scanning a preset fingerprint and opening an application program corresponding to the preset fingerprint, if an operation corresponding to the function operation instruction is setting different application programs to be controlled by different fingerprints.

By means of scanning a preset fingerprint to open an application program corresponding to the preset fingerprint, the complexity arisen from opening an application program via an interface is avoided.

More preferably, the method also comprises the step:
displaying a time setup interface of encrypted information or a time setup interface of decrypted information, if an operation corresponding to the function operation instruction is setting view time of encrypted information or display time of decrypted information.

Specifically, a user can set view time of encrypted information in a time setup interface of encrypted information, and set display time of decrypted information in a time setup interface of decrypted information as required, so that the user only can view encrypted information in specified time, and the decrypted information is displayed only in specified time after the user obtains the decrypted information by decryption. Thus, the safety of information is ensured and the user can conveniently arrange the related matters.

More preferably, the method also comprises the step of:
operating a corresponding external device according to a preset operation process, if an operation corresponding to the function operation instruction is operating an external device.

The external device includes a personality electronic display, an external camera which can be operated to make 3D files in terms of a preset operation process, an external vibration sound reading device which can be operated to help a user who can not make a sound read a sound, and a sound change device which can be operated to change a original sound to produce another sound with personality, such as, a male voice is changed to a female voice, or an animal voice.

More preferably, the method also comprises the step:
acquiring shopping information of the user and confirming the shopping information to generate a confirmation receipt, if an operation corresponding to the function operation instruction is information confirmation.

Still more preferably, after acquiring a function operation instruction input by a user the method also comprises steps of:
inquiring a corresponding relationship between the preset function operation instruction and operations;
judging if an operation corresponding to the function operation instruction is inquired;
judging the type of the operation corresponding to the function operation instruction, if the inquiry result for inquiry is yes;
scanning a fingerprint of the user and performing identity authentication on the user according to the fingerprint, if the type of the operation corresponding to the function operation instruction is authentication;
storing data information into a preset storage space, if the type of the operation corresponding to the function operation instruction is data information storage;
charging a preset device, if the type of the operation corresponding to the function operation instruction is charging.

More preferably, the method also comprises the step of:
transmitting data during preset devices if an operation corresponding to the function operation instruction is data transmission.

It is noted that the functionalities of the multifunctional MCU are not limited to the above description, and some other functionalities can be increased according to practical applications. Furthermore, the multifunctional MCUs with various functionalities can be made in different versions, and thus they can be distinguished according to the versions.

In the implementation method of the multifunctional MCU of this embodiment of the invention, by means of acquiring a function operation instruction, multiple functions can be achieved according to the operation corresponding to the function operation instruction, such as authentication, data information storage and charging. Obviously, this is very convenient for a user. A lot of functionalities can be achieved by means of a multifunctional MCU, such as encryption, decryption, screen locking, and this can be achieved simply and conveniently for a user.

### Embodiment 2

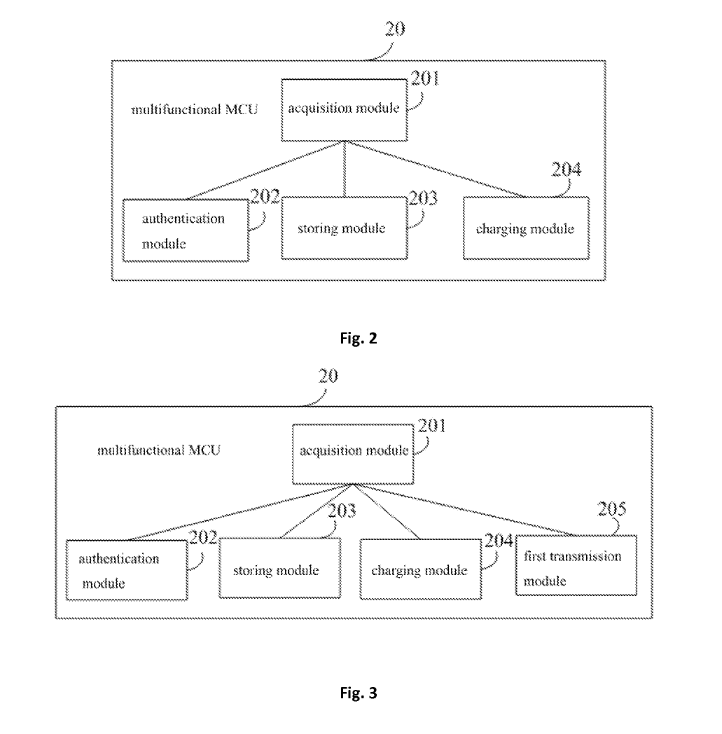

The embodiment 2 of the invention provides a multifunctional MCU, as shown in FIG. 2, such a multifunctional MCU 20 comprises:
an acquisition module 201 for acquiring a function operation instruction input by a user;
an authentication module 202, which is used for scanning a fingerprint of the user and performing identity authentication on the user according to the fingerprint, when an operation corresponding to the function operation instruction acquired by the acquisition module is authentication;
a storing module 203, which is used for storing data information into a preset storage space, when an operation corresponding to the function operation instruction acquired by the acquisition module is data information storage; and
a charging module 204, which is used for charging a preset device, when an operation corresponding to the function operation instruction acquired by the acquisition module is charging.

Specifically, a user can input a function operation instruction by means of a voice, gesture touch and switch. Correspondingly, the acquisition module 201 may be a voice acquisition module 201 (which can acquire a function operation instruction input via a voice by a user), a touch recognition module (which can acquire a function operation instruction input via gesture touch by a user), or a signal acquisition module 201 (which acquire a function operation instruction input via a switch by a user, for example, multiple switches are provided, and each switch corresponds to a function operation instruction) or the like.

Specifically, the data information may be fingerprint information of a user, or application information which is generated when a user utilizes various applications in mobile terminals, or alternatively various dada information desired to be stored by a user and the like.

Preferably, as shown in FIG. 3, this multifunctional MCU 20 also comprises:
a first transmission module 205, which is used for transmitting data during preset devices when an operation corresponding to the function operation instruction acquired by the acquisition module 201 is data transmission.

Specifically, data transmission can be performed between the multifunctional MCU and other devices, or within the multifunctional MCU.

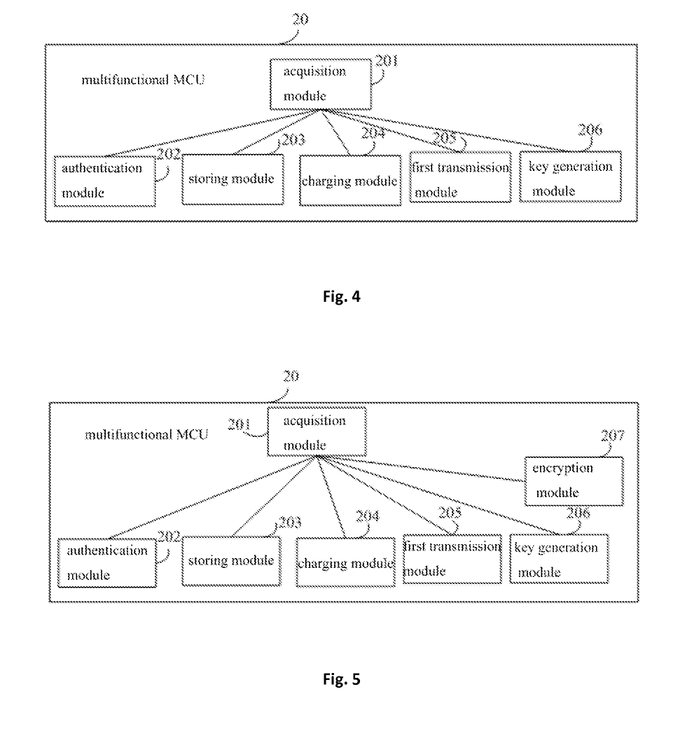

Preferably, as shown in FIG. 4, this multifunctional MCU 20 also comprises:
a key generation module 206, which is used for generating a public key and a private key according to the fingerprint of the user, and transmitting the public key to a preset storage space and storing the private key to a preset storage space, when an operation corresponding to the function operation instruction acquired by the acquisition module 201 is key generation.

Preferably, as shown in FIG. 5, this multifunctional MCU 20 also comprises:
an encryption module 207, which is used for encrypting preset communication information or a preset communication file by means of the public key, and transmitting the encrypted communication information or communication file to a receiving terminal, when an operation corresponding to the function operation instruction acquired by the acquisition module 201 is encryption.

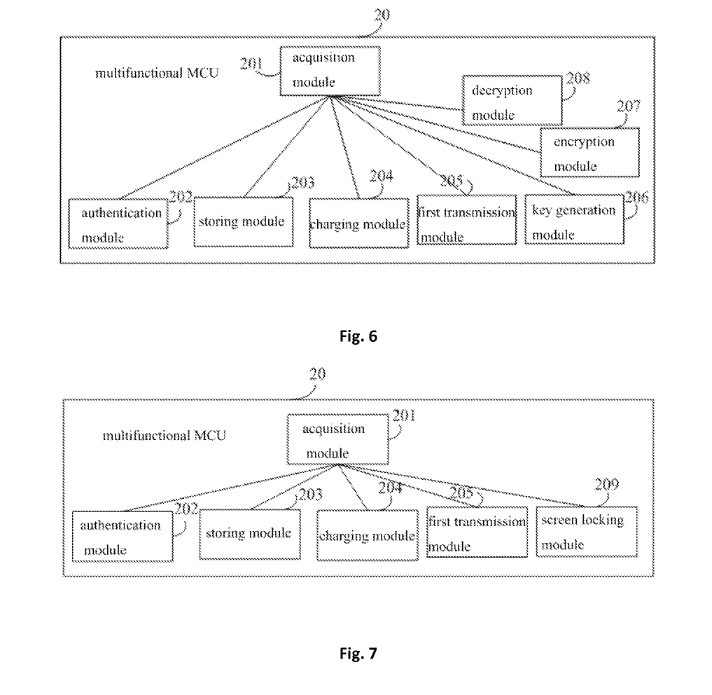

Preferably, as shown in FIG. 6, this multifunctional MCU 20 also comprises:
a decryption module 208, which is used for decrypting encrypted communication information or an encrypted communication file by means of the private key to obtain decrypted communication information or a decrypted communication file, when an operation corresponding to the function operation instruction acquired by the acquisition module 201 is decryption.

Preferably, as shown in FIG. 7, this multifunctional MCU 20 also comprises:
a screen locking module 209, which is used for locking a preset screen when an operation corresponding to the function operation instruction acquired by the acquisition module 201 is screen locking.

Preferably, as shown in FIG. 8, this multifunctional MCU 20 also comprises:
a program locking module 210, which is used for locking a preset application program, when an operation corresponding to the function operation instruction acquired by the acquisition module 201 is application program locking.

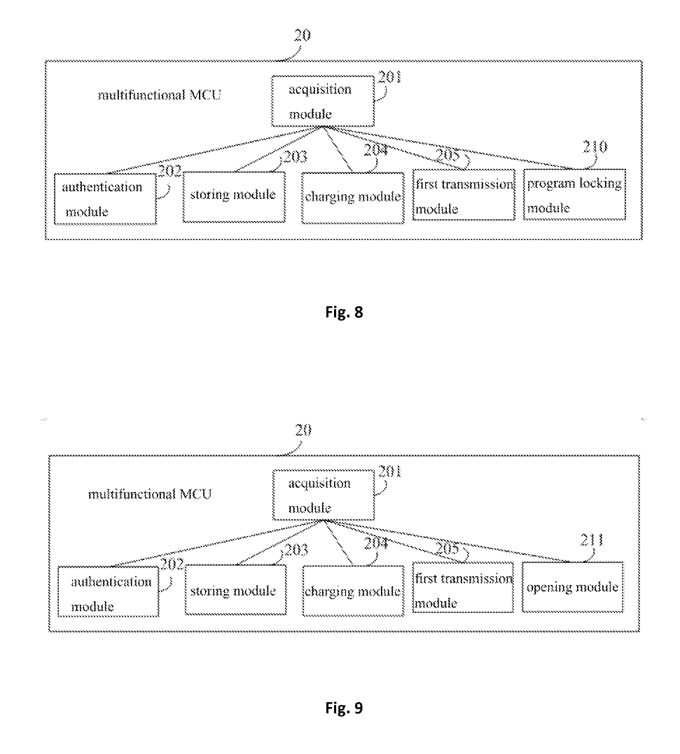

Preferably, as shown in FIG. 9, this multifunctional MCU 20 also comprises:
an opening module 211, which is used for scanning a preset fingerprint and opening an application program corresponding to the preset fingerprint, when an operation corresponding to the function operation instruction acquired by the acquisition module is setting different application programs to be controlled by different fingerprints.

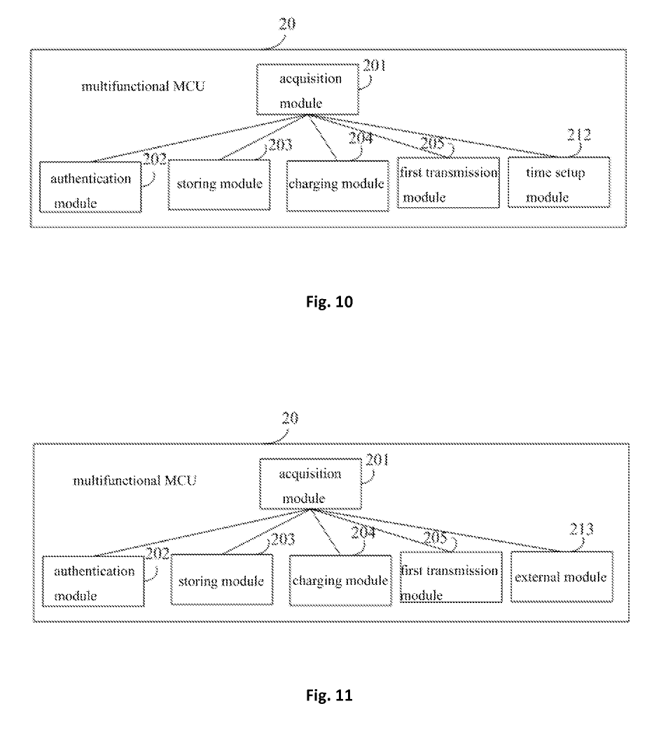

Preferably, as shown in FIG. 10, this multifunctional MCU 20 also comprises:
a time setup module 212, which is used for displaying a time setup interface of encrypted information or a time setup interface of decrypted information, when an operation corresponding to the function operation instruction acquired by the acquisition module 201 is setting view time of encrypted information or display time of decrypted information.

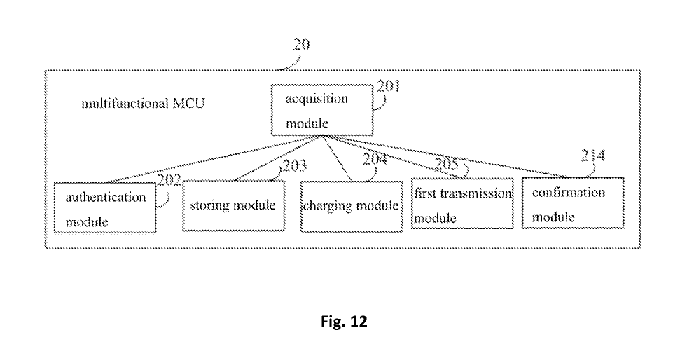

Preferably, as shown in FIG. 11, this multifunctional MCU 20 also comprises:
an external module 213, which is used for operating a corresponding external device according to a preset operation process, when an operation corresponding to the function operation instruction acquired by the acquisition module 201 is operating an external device. Preferably, as shown in FIG. 12, this multifunctional MCU 20 also comprises:
a confirmation module 214, which is used for acquiring shopping information of the user and confirming the shopping information to generate a confirmation receipt, when an operation corresponding to the function operation instruction acquired by the acquisition module 201 is information confirmation.

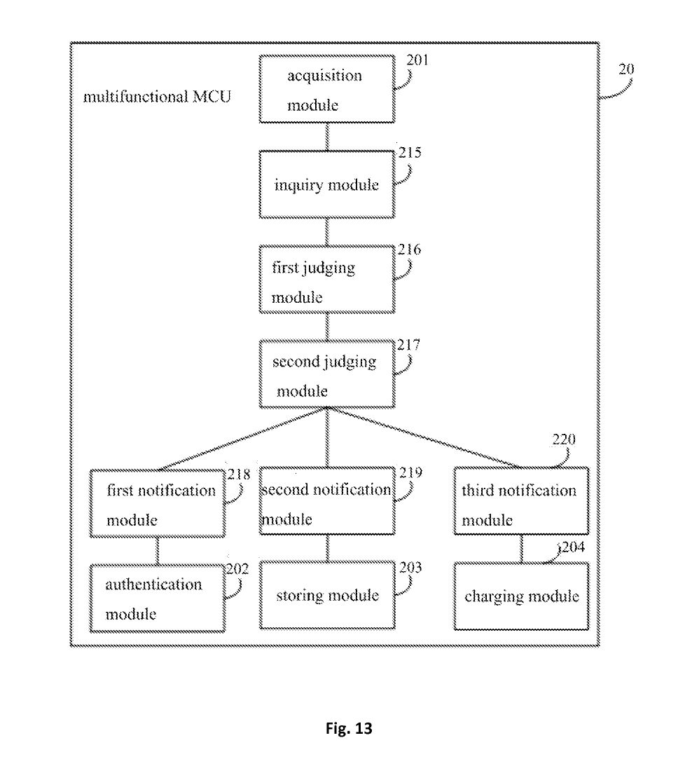

Preferably, as shown in FIG. 13, this multifunctional MCU 20 also comprises:
an inquiry module 215, which is used for inquiring a corresponding relationship between the preset function operation instruction and the operations, when the function operation instruction input by the user is acquired by the acquisition module 201;
a first judging module 216, which is used for judging if an operation corresponding to the function operation instruction is inquired by the inquiry module 215;
a second judging module 217, which is used for judging the type of the operation corresponding to the function operation instruction, when the judging result from the first judging module 216 is yes;
a first notification module 218, which is used for notifying the authentication module 202 to scan the fingerprint of the user and perform identity authentication on the user according to the fingerprint, when the judging result from the second judging module 216 is that the type of the operation corresponding to the function operation instruction is authentication;
a second notification module 219, which is used for notifying the storing module 203 to store data information into a preset storage space, when the judging result from the second judging module 217 is that the type of the operation corresponding to the function operation instruction is data information storage; and
a third notification module 220, which is used for notifying the charging module 204 to charge a preset device, when the judging result from the second judging module 217 is that the type of the operation corresponding to the function operation instruction is charging.

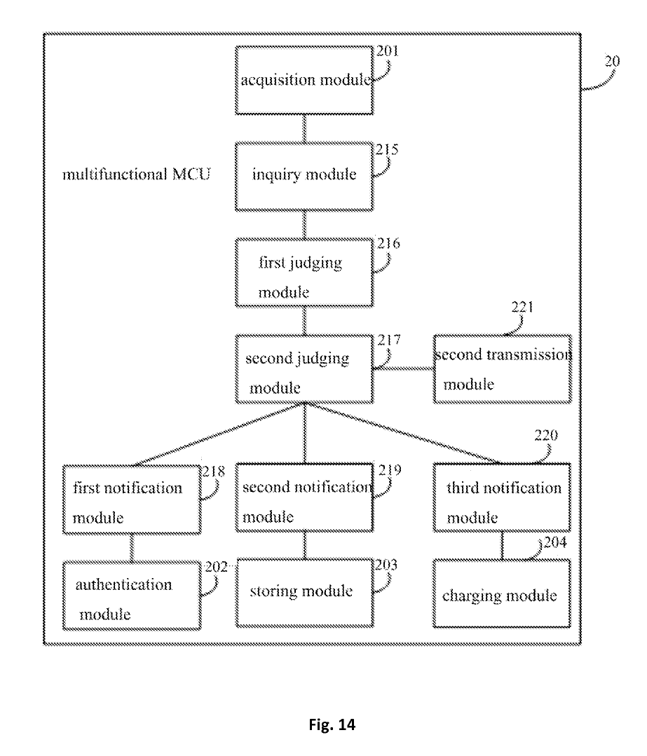

Preferably, as shown in FIG. 14, this multifunctional MCU 20 also comprises:
a second transmission module 221, which is used for transmitting data during preset devices when the judging result from the second judging module 217 is that the type of the operation corresponding to the function operation instruction is data transmission.

In the implementation method of the multifunctional MCU of this embodiment of the invention, by means of acquiring a function operation instruction, multiple functions can be achieved according to the operation corresponding to the function operation instruction, such as authentication, data information storage and charging. Obviously, this is very convenient for a user. A lot of functionalities can be achieved by means of a multifunctional MCU, such as encryption, decryption, screen locking, and this can be achieved simply conveniently for a user. The numberings of the embodiments are given only for description regardless of the quality of the embodiments.

A person skilled in the art shall appreciate that, part or all of the steps achieving the above embodiments can be completed by means of hardware, or by instructing related hardware via a program, the program may be stored in a computer-readable storage medium which may be a read only memory (ROM), secure digital card, magnetic disk or optical disc or the like.

The preferred embodiments as above described are not intended for limiting of the invention, any variations, equivalent substitutions, improvements within the spirit and scope of the invention are contained in the extent of protection of the invention.

What is claimed is:

1. An implementation method of a multifunctional MCU, comprises steps of:
acquiring a function operation instruction input by a user; and
scanning a fingerprint of the user and performing identity authentication on the user according to the fingerprint, if an operation corresponding to the function operation instruction is authentication;
storing data information into a preset storage space, if an operation corresponding to the function operation instruction is data information storage;
charging a preset device, if an operation corresponding to the function operation instruction is charging.

2. The implementation method as claimed in claim 1, wherein the method also comprises:
transmitting data during preset devices, if an operation corresponding to the function operation instruction is data transmission.

3. The implementation method as claimed in claim 1, wherein the method also comprises:
generating a public key and a private key according to the fingerprint of the user, and transmitting the public key to a preset storage space and storing the private key to a preset storage space, if an operation corresponding to the function operation instruction is key generation.

4. The implementation method as claimed in claim 3, wherein the method further comprises:
encrypting preset communication information or a preset communication file by means of the public key, and transmitting the encrypted communication information or communication file to a receiving terminal, if an operation corresponding to the function operation instruction is encryption.

5. The implementation method as claimed in claim 3, wherein the method further comprises:
decrypting encrypted communication information or an encrypted communication file by means of the private key to obtain decrypted communication information or a decrypted communication file, if an operation corresponding to the function operation instruction is decryption.

6. The implementation method as claimed in claim 1, wherein the method also comprises:
locking a preset screen if an operation corresponding to the function operation instruction is screen locking.

7. The implementation method as claimed in claim 1, wherein the method also comprises:
locking a preset application program if an operation corresponding to the function operation instruction is application program locking.

8. The implementation method as claimed in claim 1, wherein the method also comprises:
scanning a preset fingerprint and opening an application program corresponding to the preset fingerprint, if an operation corresponding to the function operation instruction is setting different application programs to be controlled by different fingerprints.

9. The implementation method as claimed in claim 1, wherein the method also comprises:
displaying a time setup interface of encrypted information or a time setup interface of decrypted information, if an operation corresponding to the function operation instruction is setting view time of encrypted information or display time of decrypted information.

10. The implementation method as claimed in claim 1, wherein the method also comprises:
operating a corresponding external device according to a preset operation process, if an operation corresponding to the function operation instruction is operating an external device.

11. The implementation method as claimed in claim 1, wherein the method also comprises:
acquiring shopping information of the user and confirming the shopping information to generate a confirmation receipt, if an operation corresponding to the function operation instruction is information confirmation.

12. The implementation method as claimed in claim 1, wherein after acquiring a function operation instruction input by a user the method also comprises steps of:
inquiring a corresponding relationship between the preset function operation instruction and operations;
judging if an operation corresponding to the function operation instruction is inquired;
judging the type of the operation corresponding to the function operation instruction, if the judging result for inquiry is yes;
scanning a fingerprint of the user and performing identity authentication on the user according to the fingerprint, if the type of the operation corresponding to the function operation instruction is authentication;
storing data information into a preset storage space, if the type of the operation corresponding to the function operation instruction is data information storage;
charging a preset device, if the type of the operation corresponding to the function operation instruction is charging.

13. A multifunctional MCU, comprises:
an acquisition module, for acquiring a function operation instruction input by a user;
an authentication module, which is used for scanning a fingerprint of the user and performing identity authentication on the user according to the fingerprint, when an operation corresponding to the function operation instruction acquired by the acquisition module is authentication;
a storing module, which is used for storing data information into a preset storage space, when an operation corresponding to the function operation instruction acquired by the acquisition module is data information storage; and
a charging module, which is used for charging a preset device, when an operation corresponding to the function operation instruction acquired by the acquisition module is charging.

14. The multifunctional MCU as claimed 13, wherein the MCU also comprises:
a first transmission module, which is used for transmitting data during preset devices, when an operation corresponding to the function operation instruction acquired by the acquisition module is data transmission.

15. The multifunctional MCU as claimed 13, wherein the MCU also comprises:
a key generation module, which is used for generating a public key and a private key according to the fingerprint of the user, and transmitting the public key to a preset storage space and storing the private key to a preset storage space, when an operation corresponding to the function operation instruction acquired by the acquisition module is key generation.

16. The multifunctional MCU as claimed 15, wherein the MCU further comprises:
an encryption module, which is used for encrypting preset communication information or a preset communication file by means of the public key, and transmitting the encrypted communication information or communication file to a receiving terminal, when an operation corresponding to the function operation instruction acquired by the acquisition module is encryption.

17. The multifunctional MCU as claimed 15, wherein the MCU further comprises:
a decryption module, which is used for decrypting encrypted communication information or an encrypted communication file by means of the private key to obtain decrypted communication information or a decrypted communication file, when an operation corresponding to the function operation instruction acquired by the acquisition module is decryption.

18. The multifunctional MCU as claimed 13, wherein the MCU also comprises:
a screen locking module, which is used for locking a preset screen when an operation corresponding to the function operation instruction acquired by the acquisition module is screen locking.

19. The multifunctional MCU as claimed 13, wherein the MCU also comprises:
a program locking module, which is used for locking a preset application program, when an operation corresponding to the function operation instruction acquired by the acquisition module is application program locking.

20. The multifunctional MCU as claimed 13, wherein the MCU also comprises:
an opening module, which is used for scanning a preset fingerprint and opening an application program corresponding to the preset fingerprint, when an operation corresponding to the function operation instruction acquired by the acquisition module is setting different application programs to be controlled by different fingerprints.

21. The multifunctional MCU as claimed 13, wherein the MCU also comprises:
a time setup module, which is used for displaying a time setup interface of encrypted information or a time setup interface of decrypted information, when an operation corresponding to the function operation instruction acquired by the acquisition module is setting view time of encrypted information or display time of decrypted information.

22. The multifunctional MCU as claimed 13, wherein the MCU also comprises:
an external module, which is used for operating a corresponding external device according to a preset operation process, when an operation corresponding to the function operation instruction acquired by the acquisition module is operating an external device.

23. The multifunctional MCU as claimed 13, wherein the MCU also comprises:
a confirmation module, which is used for acquiring shopping information of the user and confirming the shopping information to generate a confirmation receipt, when an operation corresponding to the function operation instruction acquired by the acquisition module is information confirmation.

24. The multifunctional MCU as claimed 13, wherein the MCU also comprises:
an inquiry module, which is used for inquiring a corresponding relationship between the preset function operation instruction and operations, when the function operation instruction input by the user is acquired by the acquisition module;
a first judging module, which is used for judging if an operation corresponding to the function operation instruction is inquired by the inquiry module;
a second judging module, which is used for judging the type of the operation corresponding to the function operation instruction, when the judging result from the first judging module is yes;
a first notification module, which is used for notifying the authentication module to scan the fingerprint of the user and perform identity authentication on the user according to the fingerprint, when the judging result from the second judging module is that the type of the operation corresponding to the function operation instruction is authentication;
a second notification module, which is used for notifying the storing module to store data information into a preset storage space, when the judging result from the second judging module is that the type of the operation corresponding to the function operation instruction is data information storage; and
a third notification module, which is used for notifying the charging module to charge a preset device, when the judging result from the second judging module is that the type of the operation corresponding to the function operation instruction is charging.
